(19) United States
(12) Patent Application Publication
(10) Pub. No.: US 2015/0257441 A1
(43) Pub. Date: Sep. 17, 2015

(54) Tool and Kit For Removing Closure From Electronic Cigarette

(71) Applicant: Lewis F. Gerkin, Metamora, IL (US)

(72) Inventor: Lewis F. Gerkin, Metamora, IL (US)

(21) Appl. No.: 14/209,575

(22) Filed: Mar. 13, 2014

(51) Int. Cl. A24F 15/08; B67B 7/02; A24F 47/00

(52) U.S. Cl. CPC A24F 15/08; A24F 47/002; B67B 7/02

(57) ABSTRACT

A tool configured to remove a closure from a cartridge of an electronic cigarette is provided. The tool includes a handle including a first portion and a second portion. The tool also includes a projection. The projection is configured to be inserted into a bore of the closure. The tool is configured to be pivoted with the projection located in the bore to remove the closure from the cartridge.

### BACKGROUND OF THE INVENTION

### Field of the Invention

The present invention relates generally electronic cigarettes, and more specifically to accessories configured to provide access to a cartridge with nicotine-containing liquid.

Lighting a cigarette causes tobacco to burn. The burning tobacco releases smoke that contains nicotine. In an electronic cigarette, tobacco is not burned. Instead, liquid containing nicotine is heated and converted to vapor, which a user may inhale. However, when the supply of liquid containing nicotine is exhausted it must either be replenished or a new electronic cigarette must be purchased.

Various examples of electronic cigarettes, their components, and their operation are described in, for example, U.S. Patent Application Publication No. 2013/0192617, to Thompson; U.S. Patent Application Publication No. 2013/0081642, to Safari; and PCT International Application No. PCT/US2012/033329, to Levitz et al., each of which is incorporated herein by reference in its entirety.

### SUMMARY OF THE INVENTION

In one embodiment, a tool configured to remove a closure from a cartridge of an electronic cigarette is provided. The closure has a bore and an outer surface defining an aperture providing access to the bore. The tool includes a handle. The handle includes a first portion and a second portion extending generally perpendicular to the first portion. The tool includes a pressure application feature extending radially outwardly from the second portion. The tool includes a projection projecting from the pressure application feature. The projection is configured to be inserted through the aperture into the bore. The tool is configured to be pivoted with the projection located in the bore to apply pressure with the pressure application feature to the outer surface of the closure to remove the closure from the cartridge.

In another embodiment, an electronic cigarette refill kit is provided. The kit includes a container including fluid containing nicotine. The kit includes a tool configured to remove a closure from a cartridge of an electronic cigarette. The closure has a bore therethrough. The tool includes a handle and a projection configured to be located in the bore and to extend through the closure. The projection is configured to compress a portion of the closure against a wall of the cartridge and to remove the closure from the cartridge to allow the fluid containing nicotine to be added to the cartridge. The kit includes packaging containing the container and the tool.

In another embodiment, a tool configured to remove a closure from a cartridge of an electronic cigarette is provided. The closure has a first portion and a second portion. The second portion is configured to be inserted into the cartridge. The first portion has an outer surface including an aperture providing access to a bore defined through the first portion and the second portion. The tool includes a handle. The handle has a first portion and a second portion extending generally perpendicular to the first portion. The tool includes a projection extending generally parallel to the second portion of the handle. The tool includes a disk extending radially outwardly and located between the second portion of the handle and the projection. The projection is configured to be inserted into the bore and the handle is configured to be pivoted to remove the closure from the cartridge.

Alternative exemplary embodiments relate to other features and combinations of features as may be generally recited in the claims.

### DESCRIPTION OF THE DRAWINGS

This application will become more fully understood from the following detailed description, taken in conjunction with the accompanying figures, wherein like reference numerals refer to like elements in which:

FIG. 1 is a perspective view of an embodiment of an electronic cigarette;

FIG. 2 is an exploded view of an embodiment of an electronic cigarette;

FIG. 2A is an end view of an embodiment of a closure;

FIG. 2B is an end view of an embodiment of a cartridge;

FIG. 3 is a perspective view of an embodiment of a tool configured to provide access to the interior of a cartridge of an electronic cigarette;

FIG. 3A is a side view of an embodiment of a tool configured to provide access to the interior of a cartridge of an electronic cigarette;

FIG. 3B is a rear view of an embodiment of a tool configured to provide access to the interior of a cartridge of an electronic cigarette;

FIG. 4 is a front view of an embodiment of a tool configured to provide access to the interior of a cartridge of an electronic cigarette;

FIG. 5 is an end view of an embodiment of an electronic cigarette;

FIG. 6 is a perspective view of an embodiment of a tool configured to provide access to the interior of a cartridge of an electronic cigarette illustrating the tool being configured to access a bore in the closure of the cartridge of an electronic cigarette;

FIG. 7 is perspective view of an embodiment of a tool configured to provide access to the interior of a cartridge of an electronic cigarette with a projection of the tool located in the bore through the closure of the cartridge of an electronic cigarette;

FIG. 8 is a side view of an embodiment of a tool configured to provide access to the interior of a cartridge of an electronic cigarette with a projection of the tool located in the bore through the closure of the cartridge of an electronic cigarette;

FIG. 9 is a top view of an embodiment of a tool configured to provide access to the interior of a cartridge of an electronic cigarette with a projection of the tool located in the bore through the closure of the cartridge of an electronic cigarette;

FIG. 10 is a partial cross-sectional view taken along the line 10-10 in FIG. 9 illustrating an embodiment of a tool configured to provide access to the interior of a cartridge of an electronic cigarette with a projection of the tool located in the bore through the closure of the cartridge of an electronic cigarette;

FIG. 11 is a partial cross-sectional view illustrating an embodiment of the tool being used to remove the closure of the cartridge of an electronic cigarette;

FIG. 12 is a partial cross-sectional view illustrating a projection of an embodiment of a tool configured to provide access to the interior of a cartridge of an electronic cigarette located in the bore through the closure of the cartridge of an electronic cigarette with the closure removed from the cartridge;

FIG. 13 is a partial cross-sectional view illustrating an embodiment of the tool being used to remove the closure of the cartridge of an electronic cigarette;

FIG. 14 is a perspective view of an embodiment of three tools each configured to provide access to the interior of a cartridge of an electronic cigarette and a container of fluid containing nicotine packaged together in packaging;

FIG. 15 is a perspective view of an embodiment of a tool configured to provide access to the interior of a cartridge of an electronic cigarette; and

FIG. 16 is a perspective exploded view of an embodiment of a tool configured to provide access to the interior of a cartridge of an electronic cigarette.

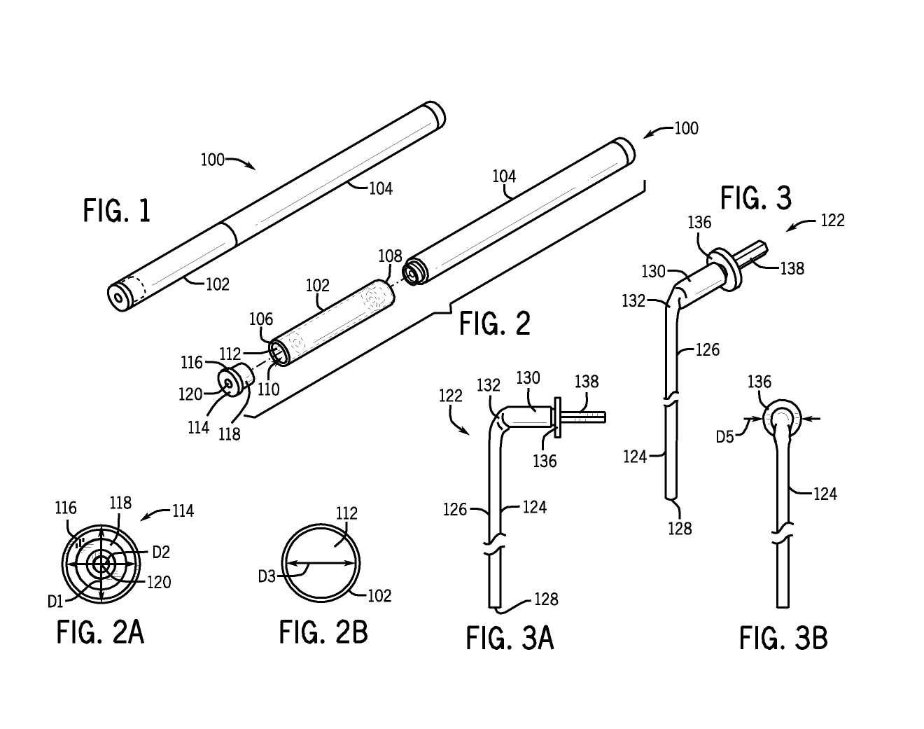

### DETAILED DESCRIPTION OF THE EXEMPLARY EMBODIMENTS

Generally, an embodiment of an electronic cigarette 100, may be sold with a limited quantity of fluid (e.g., liquid, propylene glycol, etc.) containing nicotine in a cartridge 102. The electronic cigarette 100 includes a portion 104 that may contain components that are configured for extended use, e.g., not to wear out, break, etc., for additional uses after the fluid in the cartridge 102 is expended. In one embodiment, the portion may include, e.g., an atomizer, heating coil, voltage control, battery, LED indicator, etc. Thus, when the fluid in the cartridge 102 is expended, it may be desirable to refill the cartridge 102 to allow for continued use of the components in the portion 104.

With reference to FIG. 2, in one embodiment, the cartridge 102 may be detached from, e.g., decoupled from, unscrewed from, etc., the portion 104. The cartridge 102 is generally cylindrical and extends from a first end 106 to a second end 108. The cartridge 102 defines a chamber 110. The first end 106 defines an aperture 112 through which access is provided to the chamber 110. A closure, shown in FIG. 2 as a plug 114, is provided. The plug 114 is configured to close the aperture 112 of the cartridge 102 blocking access to the chamber 110.

With reference to FIGS. 2 and 2A, in one embodiment, the plug 114 includes a first portion 116 and a second portion 118 extending from the first portion 116. The first portion 116 has a diameter D1. The second portion 118 has a diameter D2. The diameter D1 is greater than the diameter D2. With reference to FIG. 2B, the aperture 112 of the cartridge 102 has a diameter D3. The diameter D3 is generally less than the diameter D1 (shown in FIG. 2A). The second portion 118 is configured to be inserted through the aperture 112 and be retained in the cartridge 102 by a friction fit with the wall of the cartridge 102 (e.g., the diameter D2 of the second portion 118 is generally the same as the diameter D3 of the aperture 112, such that the second portion 118 tends to be retained in the cartridge 102). The first portion 116 remains outside the cartridge 102 abutting the first end 106 of the cartridge 102.

In one embodiment, the second portion 118 of the plug 114 is formed from deformable and/or compressible material (e.g., rubber, plastic, etc.) and is configured to deform and/or compress radially inwardly when inserted into the cartridge 102 and to resiliently press outwardly against the interior wall of the cartridge 102, tending to retain the second portion 118 inside the cartridge 102.

With further reference to FIGS. 2 and 2A, in one embodiment, the first portion 116 of the plug 114 includes an outer surface that defines an aperture. The aperture provides access to a central bore 120 extending through the first 116 and second 118 portions. In one embodiment, when the electronic cigarette 100 is in an assembled configuration, vapor created from the liquid containing nicotine in the cartridge 102 is configured to travel through the bore 120 to exit the electronic cigarette 100 and travel to the user.

With reference to FIGS. 3 and 3B, an embodiment of a tool configured to provide access to the interior of a cartridge of an electronic cigarette, shown in FIG. 3 as tool 122, is illustrated. The tool 122 includes a handle portion 124. The handle portion 124 includes a first portion, shown as a first generally cylindrical portion 126, extending from a first end 128 to a second portion 130. In one embodiment, the first portion 126 is longer than the second portion 130. The second portion 130 extends generally perpendicular to the first portion 126 from a second end 132 of the first portion 126 distal from the first end 128 of the first portion 126. The second portion 130 extends from the first portion 126 to a pressure application feature shown as a disk 136. The disk 136 extends radially outwardly generally perpendicular to the second portion 130. The disk 136 has a diameter D5. In one embodiment, the diameter D5 is less than the diameter D1 of the first portion 116 of the plug 114 (see FIG. 2A).

With further reference to FIGS. 3 and 3A, in one embodiment, the tool 122 includes a projection 138 projecting from the disk 136, generally aligned with and parallel to the second portion 130, e.g., the axis along which the second portion 130 extends and the axis along which projection 138 are generally coaxial, for example, the same axis. In one embodiment, the second portion 130 and the projection 138 each surround the same longitudinal axis. In one embodiment, the projection 138 is a multi-sided projection, having a multi-sided outer surface, e.g., square, pentagon, hexagon, heptagon, octagon, nonagon, etc. In other embodiments, the projection 138 may be round, oval-shaped, etc. In other embodiments, the projection 138 is non-round, e.g., non-circular, which may allow the projection 138 to engage the closure 114 and tend to maintain its rotational orientation relative to the closure 114.

In one embodiment, the handle portion 124 and the projection 138 are unitarily formed, with the disk 136 having a central bore through which the projection 138 is inserted to form the tool 122. In other embodiments, the handle portion 124 and the projection 138 may be separated formed and coupled by any suitable mechanism. In one embodiment, the handle portion 124 may include a core portion covered and/or partially covered with a grip layer, e.g., rubber, plastic, etc., to provide improved gripping of the handle portion 124 by a user. In one embodiment, the grip layer is a coating. In another embodiment, the grip layer is a sleeve.

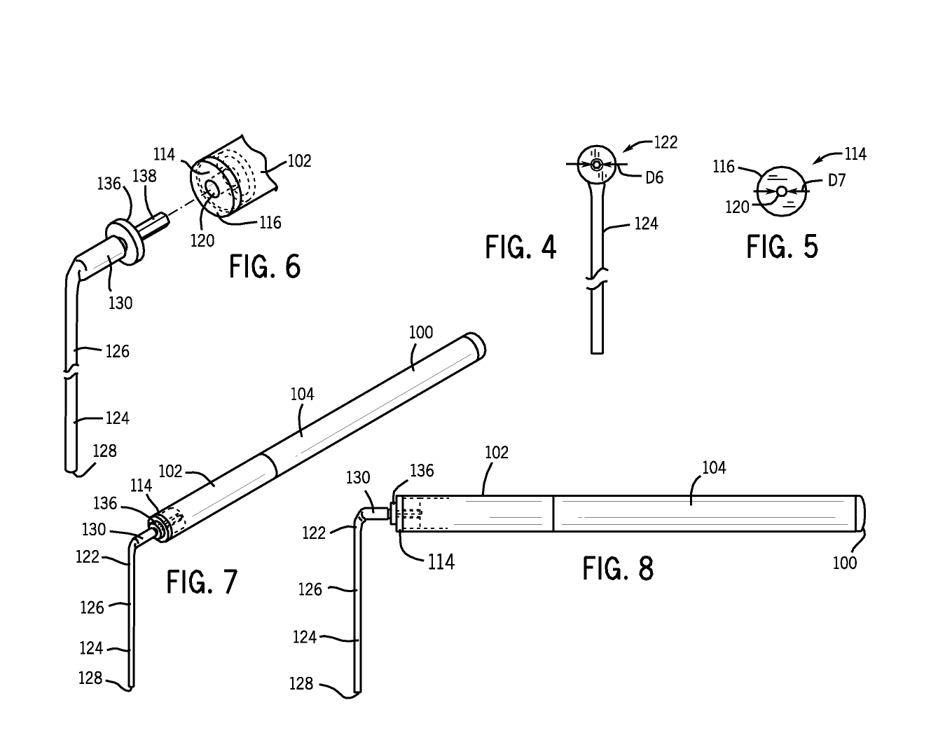

With reference to FIG. 4, in one embodiment, the projection 138 has a maximum width D6. With reference to FIG. 5, the central bore 120 of the plug 114 has a diameter D7. The projection 138 is sized to allow the projection 138 to be inserted into the bore 120.

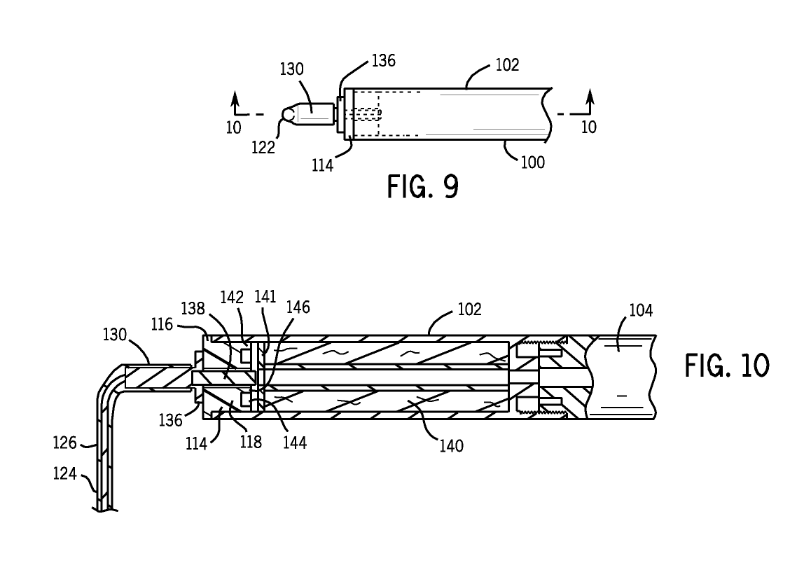

With reference to FIGS. 6 through 8, in one embodiment, to remove the plug 114 from the cartridge 102, the projection 138 is inserted into the bore 120. The disk 136 abuts the outer surface of the first portion 116 of the plug 114. With reference to FIGS. 9 and 10, the tool 122 is illustrated with the projection 138 located in the bore 120 of the plug 114. In some embodiments, the cartridge 102 includes filler material 140 into which fluid containing nicotine may be deposited. Additionally, in one embodiment, a barrier 141, e.g., a screen, plastic divider, etc., may be provided between the filler material 140 and the plug 114.

With further reference to FIG. 10, in one embodiment, the second portion 118 of the plug 114 includes an annular outer wall 142. The second portion 118 defines an annular channel 144 bounded on its radially outer edge by the annular outer wall 142 and bounded on its radially inner edge by an annular inner wall 146 which defines the bore 120.

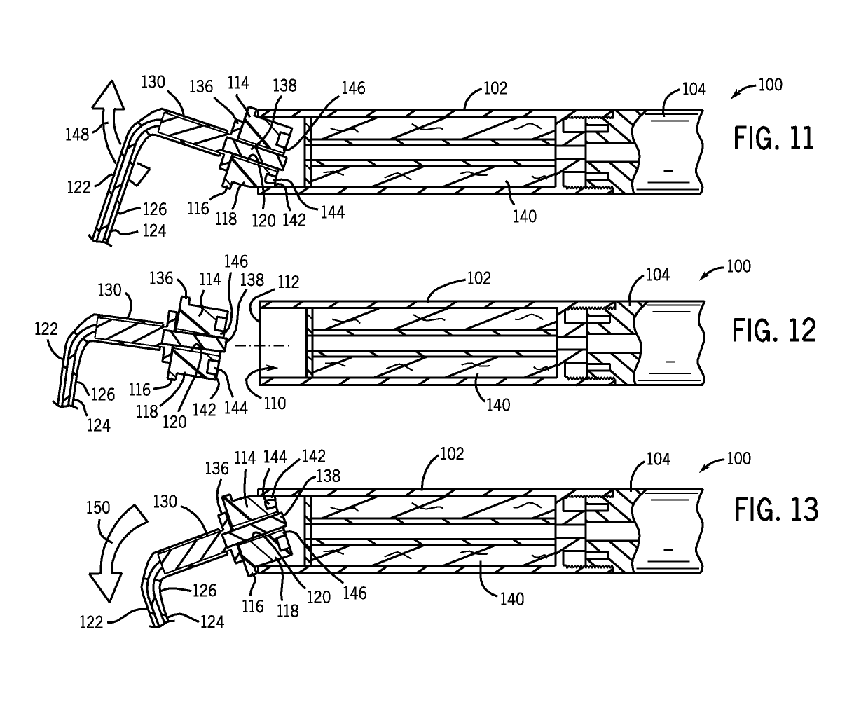

With reference to FIGS. 11 and 12, removal of a plug 114 by a first embodiment of a removal method using an embodiment of a tool 122 is illustrated. With the projection 138 located in the bore 120, the handle portion 124 is pivoted upwardly in the direction indicated by the arrow 148, with the disk 136 applying pressure to the outer surface of the first portion 116 of the plug 114. The annular outer wall 142 of the plug 114 is deformed inwardly by the wall of the cartridge 102 reducing the size of the channel 144 and allow the lower edge of the plug 114 to slide along the wall of the cartridge 102 until it is removed from the cartridge 102 and the plug 114 is then freely removable by the tool 122. FIG. 12 illustrates the plug 114 removed from the cartridge 102 with the projection 138 located in the bore 120. The cartridge 102 may then be refilled by adding liquid containing nicotine through the aperture 112 and into the chamber 110.

FIG. 13 illustrates removal of a plug 114 by a second embodiment of a removal method using an embodiment of a tool 122. With the projection 138 located in the bore 120, the handle portion 124 is pivoted downwardly in the direction indicated by the arrow 150, with the disk 136 applying pressure to the outer surface of the first portion 116 of the plug 114, which causes the upper portion of the annular outer wall 142 to be deflected radially inwardly, compressing the second portion 118 of the plug 114 against the wall of the cartridge 102, decreasing the size of the channel 144, and allowing the upper edge of the annular outer wall 142 to slide along the wall of the cartridge 102 to remove the plug 114 from the cartridge 102.

In one embodiment, the length of the projection 138, e.g., the distance from the disk 136 to the end of the projection 138 is greater than the length of the bore 120. In other embodiments, projections may be shorter than the length of the bore 120.

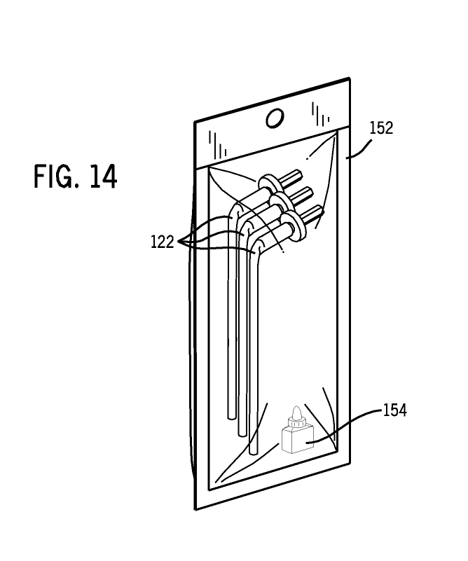

With reference to FIG. 14, in one embodiment, a plurality of tools 122 may be packaged together in packaging 152 and sold. In the illustrated embodiment, three tools 122 are shown packaged together, however, any suitable number of tools may be provided in packaging. In another embodiment, a container 154 including fluid containing nicotine may be provided and packaged together with one or any other suitable number of tools 122 and sold as an electronic cigarette refill kit. In another embodiment, one or any other suitable number of tools 122 may be packaged with an electronic cigarette and sold. In another embodiment, one or any other suitable number of tools 122 may be packaged with a container 154 including fluid containing nicotine and an electronic cigarette may all be packaged together and sold.

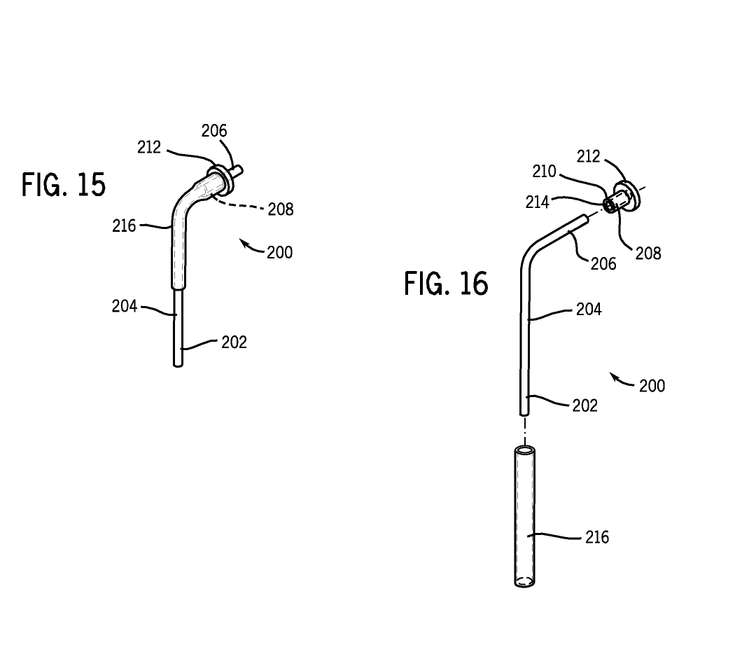

With reference to FIGS. 15 and 16, another embodiment of a tool configured to provide access to the interior of a cartridge of an electronic cigarette, shown in FIGS. 15 and 16 as tool 200, is illustrated. The tool 200 includes a generally L-shaped handle portion 202. The handle portion 202 includes a first, generally cylindrical portion 204 and a second, generally cylindrical portion 206 extending generally perpendicularly to the first portion 204 from one end of the first portion. In one embodiment, the first portion 204 is longer than the second portion 206.

The tool 200 includes sleeve 208. The sleeve 208 includes a generally cylindrical tube portion 210 and a pressure application feature shown as a disk 212. The tube portion 210 and the disk 212 define a throughbore 214 configured to allow at least a portion of the second portion 206 to pass therethrough. In one embodiment, the tube portion 210 and the disk 212 are unitarily formed. In one embodiment, the sleeve 208 is a grommet. In one embodiment, the sleeve 208 is a metal sleeve. In other embodiments, the sleeve 208 may be formed from any other suitable material. In one embodiment, the disk 212 is a generally circular disk.

In one embodiment, the tool 200 also includes a film sleeve 216. With a portion of the second portion 206, e.g., a projection, projecting through the throughbore 214 and past the disk 212, the film sleeve 216 may be placed over at least a portion of the handle 202 and at least a portion of the tube portion 210. In one embodiment, the film sleeve 216 is then shrunk, coupling the sleeve 208 to the handle 202. In one embodiment, the film sleeve 216 may be shrink wrap, shrink film, polymer plastic film, polyolefin, polyethylene, polypropylene, polyvinyl chloride, or any other suitable material. In other embodiments, other mechanisms may be used to couple the sleeve 208 to the handle 202.

Embodiments of tool 200 may be used as described above with regard to tool 122 above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. The position of elements may be reversed or otherwise varied, and the nature or number of discrete elements or positions may be altered or varied. The order or sequence of some process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed is:

1. A tool configured to remove a closure from a cartridge of an electronic cigarette, the closure having a bore and an outer surface defining an aperture providing access to the bore, the tool comprising:
a handle including a first portion and a second portion extending generally perpendicular to the first portion;
a pressure application feature extending radially outwardly from the second portion; and
a projection projecting from the pressure application feature;
wherein the projection is configured to be inserted through the aperture and into the bore; and
wherein the tool is configured to be pivoted with the projection located in the bore to apply pressure with the pressure application feature to the outer surface of the closure to remove the closure from the cartridge.

2. The tool of claim 1, wherein the projection has a first width; and
wherein the pressure application feature has a second width; and
wherein the second width is greater than the first width.

3. The tool of claim 2, wherein the pressure application feature is a generally circular disk; and
wherein the second width is a diameter of the generally circular disk.

4. The tool of claim 1, wherein the projection is hexagonally shaped.

5. The tool of claim 1, wherein the projection extends generally parallel to the second portion of the handle; and
wherein the projection and the second portion of the handle are unitarily formed.

6. The tool of claim 1, wherein the second portion of the handle extends along a first axis; and
wherein the projection extends along a second axis; and
wherein the first axis and the second axis are generally coaxial.

7. The tool of claim 1, wherein the handle includes a covering layer covering the first portion.

8. The tool of claim 7, wherein the covering layer covers the second portion of the handle.

9. An electronic cigarette refill kit comprising:
a container including fluid containing nicotine;
a tool configured to remove a closure from a cartridge of an electronic cigarette, the closure having a bore therethrough, the tool including a handle and a projection configured to be located in the bore and to extend through the closure, the projection being configured to compress a portion of the closure against a wall of the cartridge and to remove the closure from the cartridge to allow the fluid containing nicotine to be added to the cartridge; and
packaging containing the container and the tool.

10. The kit of claim 9, further comprising a second tool configured to remove a closure from a cartridge of an electronic cigarette.

11. The kit of claim 9, further comprising an electronic cigarette.

12. The kit of claim 10, further comprising an electronic cigarette.

13. The kit of claim 9, wherein the handle includes a first portion and a second portion extending generally perpendicular to the first portion.

14. The kit of claim 13, wherein the tool includes a disk between the second portion and the projection.

15. The kit of claim 14, wherein the disk is generally circular and has a first diameter; and
wherein the projection has a maximum width; and
wherein the first diameter is greater than the maximum width.

16. The kit of claim 14, wherein the second portion of the handle and the projection each surround the same longitudinal axis.

17. The kit of claim 9, wherein the closure includes a portion configured to be inserted into the cartridge including an outer annular wall and an inner annular wall spaced apart from the outer annular wall;
wherein the outer and inner annular walls each are concentric with the bore; and
wherein the projection is configured to cause the outer inner wall to be deflected by the wall of the cartridge toward the inner annular wall to allow removal of the closure from the cartridge.

18. A tool configured to remove a closure from a cartridge of an electronic cigarette, the closure having a first portion and a second portion, the second portion being configured to be inserted into the cartridge, the first portion having an outer surface including an aperture providing access to a bore defined through the first portion and the second portion, the tool comprising:
a handle, having a first portion and a second portion extending generally perpendicular to the first portion;
a projection extending generally parallel to the second portion of the handle; and
a disk extending radially outwardly and located between the second portion of the handle and the projection;
wherein the projection is configured to be inserted into the bore and the handle is configured to be pivoted to remove the closure from the cartridge.

19. The tool of claim 18, wherein the disk is generally circular and has a diameter; and
wherein the projection has a maximum width; and
wherein the diameter of the disk is greater than the maximum width of the projection.

20. The tool of claim 18, wherein the first portion of the handle is longer than the second portion of the handle.
